(19) United States
(12) Patent Application Publication
(10) Pub. No.: US 2023/0042085 A1
(43) Pub. Date: Feb. 9, 2023

(54) TRACK SYSTEM FOR TRACTION OF A VEHICLE

(71) Applicant: CAMSO INC., MAGOG (CA)

(72) Inventor: JEAN TURCOTTE, SHERBROOKE (CA)

(73) Assignee: CAMSO INC., MAGOG, QC (CA)

(21) Appl. No.: 17/794,707

(22) PCT Filed: Jan. 22, 2021
(86) PCT No.: PCT/CA2021/050072

§ 371 Date: Jul. 22, 2022

Related U.S. Application Data
(60) Provisional application No. 62/964,617, filed on Jan. 22, 2020.

(51) Int. Cl. B62D 55/24; B62D 55/26

(52) U.S. Cl. CPC B62D 55/244; B62D 55/26

(57) ABSTRACT

A track for a vehicle (e.g., an agricultural vehicle) is configured to enhance traction and/or floatation on a ground (e.g., of an agricultural field) while reducing pressure (i.e., applying substantially no or less pressure) on a selected region of the ground (e.g., a planting row of the agricultural field, such as to reduce soil compaction for promoting plant growth) and/or to improve roading (e.g., travel faster on a road).

### CROSS-REFERENCE TO RELATED APPLICATION

This application claims priority from U.S. Patent Application 62/964,617 filed on Jan. 22, 2020 and hereby incorporated by reference herein.

### FIELD

This disclosure relates generally to vehicles and, more particularly, to vehicles comprising track systems for traction.

### BACKGROUND

Certain vehicles, including industrial vehicles such as agricultural vehicles (e.g., harvesters, combines, tractors, etc.), construction vehicles (e.g., excavators, bulldozers, loaders, etc.), and forestry vehicles (e.g., feller-bunchers, tree chippers, knuckleboom loaders, etc.), military vehicles (e.g., combat engineering vehicles (CEVs), etc.), snowmobiles, and all-terrain vehicles (ATVs), for example, may be equipped with track systems to enhance their traction and floatation on soft, slippery and/or irregular grounds (e.g., soil, mud, sand, ice, snow, etc.) on which they operate.

Track systems comprise a track and a track-engaging assembly (e.g., comprising wheels) for driving and guiding their track around their track-engaging assembly to distribute a weight of the vehicle on the ground. As vehicles and work implements of the vehicles are getting heavier, track systems tend to compact the grounds at a greater pressure, which can be damageable for performances (e.g., traction, floatation, maximum speed) of the track system and of the vehicle.

To remedy this, a width of the track can be increased. However, this may be damageable to certain applications. For example, this can result in compacting soil over planting rows of crops, which can detrimentally affect growth of the crop rows.

Track systems with a contact patch between the track and the ground having an increased length also exist, but they are heavier and more expensive to manufacture and transport.

For these and other reasons, there is a need to improve track systems for vehicles.

### SUMMARY

According to various aspects, this disclosure relates to a track for a vehicle (e.g., an agricultural vehicle) in which the track is configured to enhance traction and/or floatation on a ground (e.g., of an agricultural field) while reducing pressure (i.e., applying substantially no or less pressure) on a selected region of the ground (e.g., a planting row of the agricultural field, such as to reduce soil compaction for promoting plant growth) and/or to improve roading (e.g., travel faster on a road).

For example, according to a first aspect, there is provided a track for traction of a vehicle. The track is mountable around a track-engaging assembly comprising a plurality of wheels. The track is elastomeric to flex around the track-engaging assembly. The track comprises: a carcass comprising a ground-engaging outer surface for engaging a ground and an inner surface opposite to the ground-engaging outer surface; and a plurality of traction projections projecting from the ground-engaging outer surface. The track comprises a pressure-reducing zone configured to cause pressure on the ground beneath the pressure-reducing zone of the track to be lower than pressure on the ground beneath an adjacent portion of the track that is adjacent to the pressure-reducing zone of the track in a widthwise direction of the track.

According to another aspect, there is provided a track for traction of a vehicle. The track is mountable around a track-engaging assembly comprising a plurality of wheels. The track is elastomeric to flex around the track-engaging assembly. The track comprises: a carcass comprising a ground-engaging outer surface for engaging a ground and an inner surface opposite to the ground-engaging outer surface; and a plurality of traction projections projecting from the ground-engaging outer surface. A thickness of the carcass from the ground-engaging outer surface to the inner surface varies in a widthwise direction of the track to cause pressure on the ground beneath a thinner portion of the carcass to be lower than pressure on the ground beneath a thicker portion of the carcass that is adjacent to the thicker portion of the carcass in the widthwise direction of the track.

According to another aspect, there is provided a method of reducing soil compaction by an agricultural vehicle on an agricultural field. The method comprises providing a track for traction of the agricultural vehicle, the track being mountable around a track-engaging assembly comprising a plurality of wheels, the track being elastomeric to flex around the track-engaging assembly. The track comprises: a carcass comprising a ground-engaging outer surface for engaging a ground and an inner surface opposite to the ground-engaging outer surface; and a plurality of traction projections projecting from the ground-engaging outer surface. The track comprises a pressure-reducing zone configured to cause pressure on the ground beneath the pressure-reducing zone of the track to be lower than pressure on the ground beneath an adjacent portion of the track that is adjacent to the pressure-reducing zone of the track in a widthwise direction of the track. The method comprises causing the agricultural vehicle to move on the agricultural field such that the pressure-reducing zone of the track overlies a planting row of the agricultural field.

These and other aspects of this disclosure will now become apparent to those of ordinary skill in the art upon review of the following description of embodiments in conjunction with the accompanying drawings.

### BRIEF DESCRIPTION OF THE DRAWINGS

A detailed description of embodiments is provided below, by way of example only, with reference to the accompanying drawings, in which:

FIG. 1 shows an example of an agricultural vehicle comprising a track system in accordance with an embodiment;

FIG. 2 shows a side view of the agricultural vehicle;

FIGS. 3 to 5 show a perspective view, a side view and a plan view of a track of a given one of the track systems;

FIG. 6 shows a cross-sectional view of the track;

FIG. 7 shows an inner view of the track;

FIG. 8 shows a perspective view of a drive/guide projection of the track;

FIG. 9 shows a drive wheel of a track-engaging assembly of the track system;

FIG. 10 shows mid-rollers of the track-engaging assembly engaging an inner side of the track;

FIGS. 11 to 13 show variants of the track;

FIGS. 14 and 15 show an example of an agricultural vehicle comprising four track systems rather than two;

FIG. 16 shows an example of a trailed vehicle configured to be attached to the agricultural vehicle of FIG. 1 or 14;

FIG. 17 shows an example of a track comprising a carcass and metallic cores embedded in the carcass; and

FIGS. 18 and 19 show an example of a carcass of a track comprising stiffening bars embedded in the carcass.

It is to be expressly understood that the description and drawings are only for purposes of illustrating certain embodiments and are an aid for understanding. They are not intended to and should not be limiting.

### DETAILED DESCRIPTION OF EMBODIMENTS

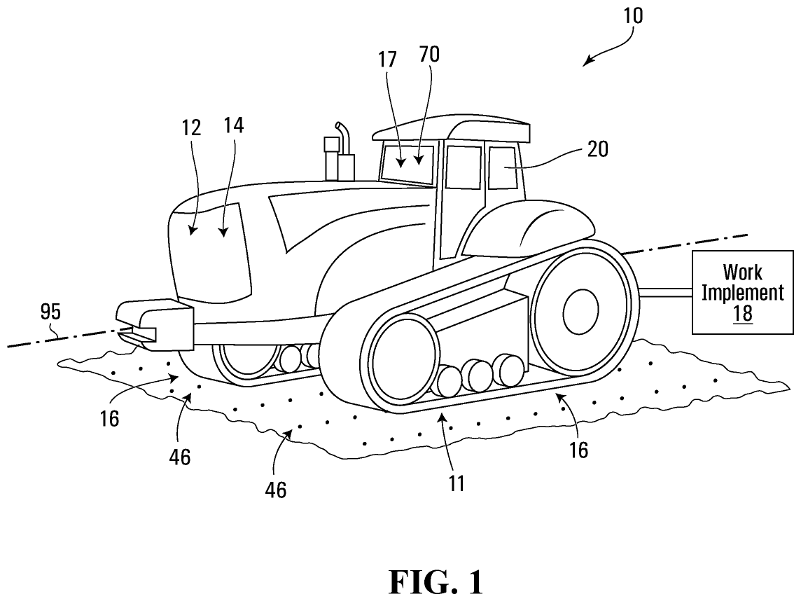

FIG. 1 shows an embodiment of a vehicle 10 comprising track systems 16 including tracks 22 for traction of the vehicle 10 on a ground. In this embodiment, the vehicle 10 is an agricultural vehicle for performing agricultural work on an agricultural field 11. Specifically, in this example, the agricultural vehicle 10 is a tractor and the agricultural field 11 comprises soil. In other examples, the agricultural vehicle 10 may be a combine harvester, another type of harvester, or any other type of agricultural vehicle.

The agricultural vehicle 10 comprises a frame 12, a powertrain 15, the track systems 16 (which can be referred to as “undercarriages”), and an operator cabin 20 that enable an operator to move the agricultural vehicle 10 on the ground. The vehicle 10 can travel on the agricultural field to perform agricultural work using a work implement 18. The vehicle 10 can also be “roading”, i.e., travelling on a road (i.e., a paved road having a hard surface of asphalt, concrete, gravel, or other pavement), such as between agricultural fields.

In this embodiment, as further discussed later, the tracks 22 are configured to enhance traction and/or floatation on the agricultural field 11 while reducing pressure (i.e., applying substantially no or less pressure) on selected regions (e.g., planting rows) of the agricultural field (e.g., for reducing soil compaction at these selected regions to promote plant growth) and/or to improve roading (e.g., travel faster on the road).

The powertrain 15 is configured for generating motive power and transmitting motive power to the track systems 16 to propel the agricultural vehicle 10 on the ground. To that end, the powertrain 15 comprises a prime mover 14, which is a source of motive power that comprises one or more motors. For example, in this embodiment, the prime mover 14 comprises an internal combustion engine. In other embodiments, the prime mover 14 may comprise another type of motor (e.g., an electric motor) or a combination of different types of motor (e.g., an internal combustion engine and an electric motor). The prime mover 14 is in a driving relationship with the track systems 16. That is, the powertrain 15 transmits motive power generated by the prime mover 14 to one or more of the track systems 16 in order to drive (i.e., impart motion to) these one or more of the track systems 16. The powertrain 15 may transmit power from the prime mover 14 to the track systems 16 in any suitable way. In this embodiment, the powertrain 15 comprises a transmission between the prime mover 14 and final drive axles 56₁, 56₂ for transmitting motive power from the prime mover 14 to the track systems 16. The transmission may be an automatic transmission (e.g., a continuously variable transmission (CVT)) or any other suitable type of transmission.

The work implement 18 is used to perform agricultural work. For example, in some embodiments, the work implement 18 may be a combine head, a cutter, a scraper pan, a tool bar, a planter, or any other type of agricultural work implement.

The operator cabin 20 is where the operator sits and controls the agricultural vehicle 10. More particularly, the operator cabin 20 comprises a user interface 70 including a set of controls that allow the operator to steer the agricultural vehicle 10 on the ground and operate the work implement 18. For example, in this embodiment, the user interface 70 comprises an accelerator, a brake control, and a steering device that are operable by the operator to control motion of the agricultural vehicle 10 on the ground and operation of the work implement 18. The user interface 70 also comprises an instrument panel (e.g., a dashboard) which provides indicators (e.g., a speedometer indicator, a tachometer indicator, etc.) to convey information to the operator.

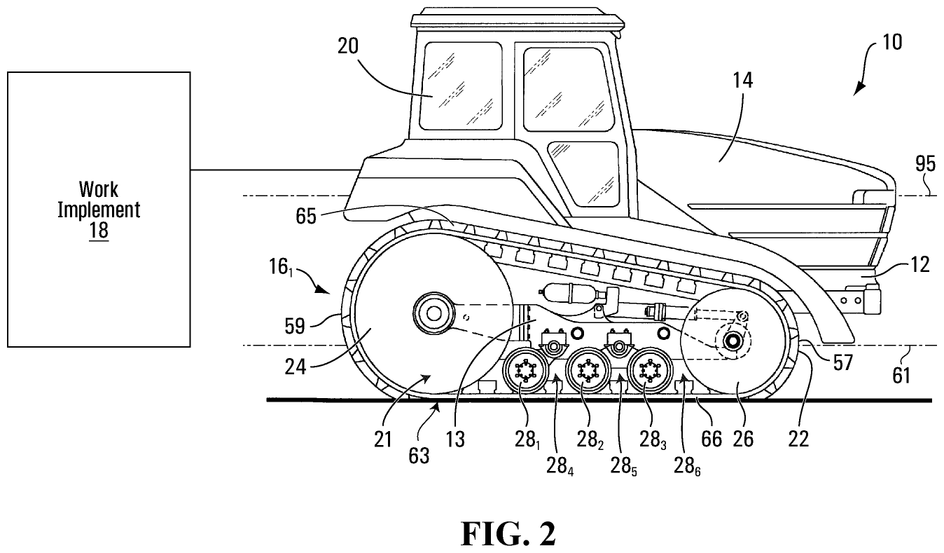

The track systems 16 engage the ground to propel the agricultural vehicle 10. As shown in FIG. 2, each track system 16 comprises a track-engaging assembly 21 and a track 22 disposed around the track-engaging assembly 21. In this embodiment, the track-engaging assembly 21 comprises a plurality of track-contacting wheels which, in this example, includes a drive wheel 24 at a first longitudinal end portion of the track system 16, and a plurality of idler wheels that includes front (i.e., leading) idler wheel 26 at a second longitudinal end portion of the track system 16 opposite to the first longitudinal end portion and a plurality of roller wheels 28₁-28₆. The track system 16 also comprises a frame 13 which supports various components of the track system 16, including the wheels 26, 28₁-28₆. The track system 16 has a longitudinal direction and a first longitudinal end 57 and a second longitudinal end 59 that define a length of the track system 16 along a longitudinal axis 61 that defines the longitudinal direction of the track system 16. The track system 16 has a widthwise direction and a width that is defined by a width W of the track 22. The track system 16 also has a heightwise direction that is normal to its longitudinal direction and its widthwise direction.

Each of the front ones of the track systems 16 is steerable by the steering system 17 of the agricultural vehicle 10 in response to input of the user at the steering device to change an orientation of that track system relative to the frame 12 of the agricultural vehicle 10 in order to steer the agricultural vehicle 10 on the ground. To that end, each of the front ones of the track systems 16 is pivotable about a steering axis 25 of the agricultural vehicle 10. An orientation of the longitudinal axis 61 of each of the front ones of the track systems 16 is thus adjustable relative to a longitudinal axis 95 of the agricultural vehicle 10.

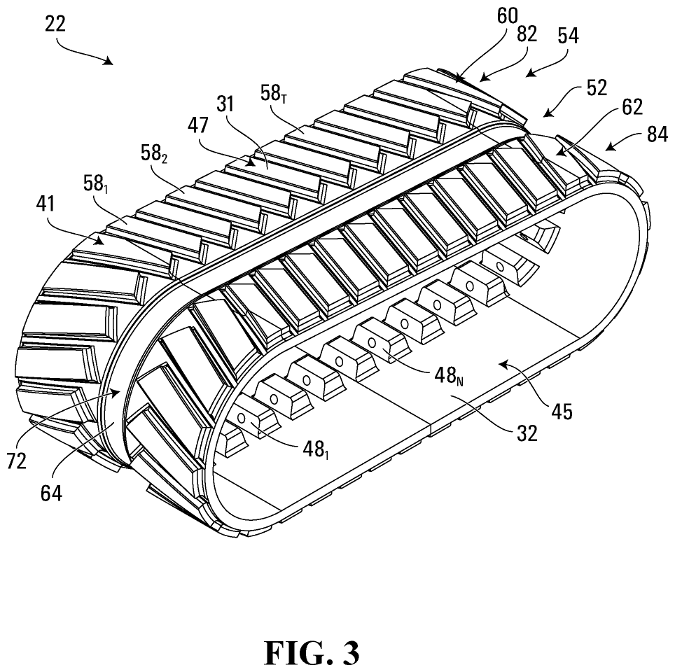

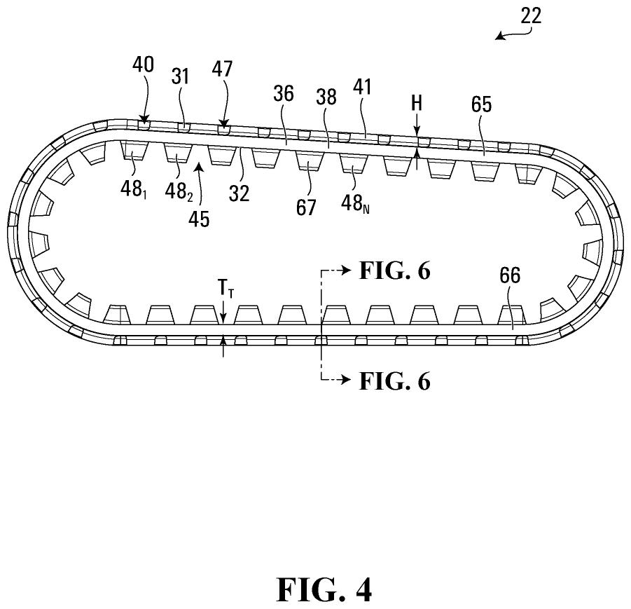

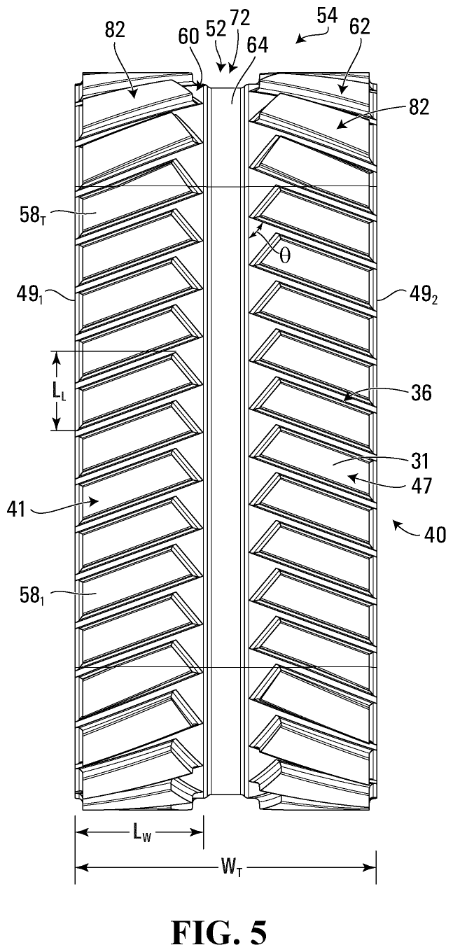

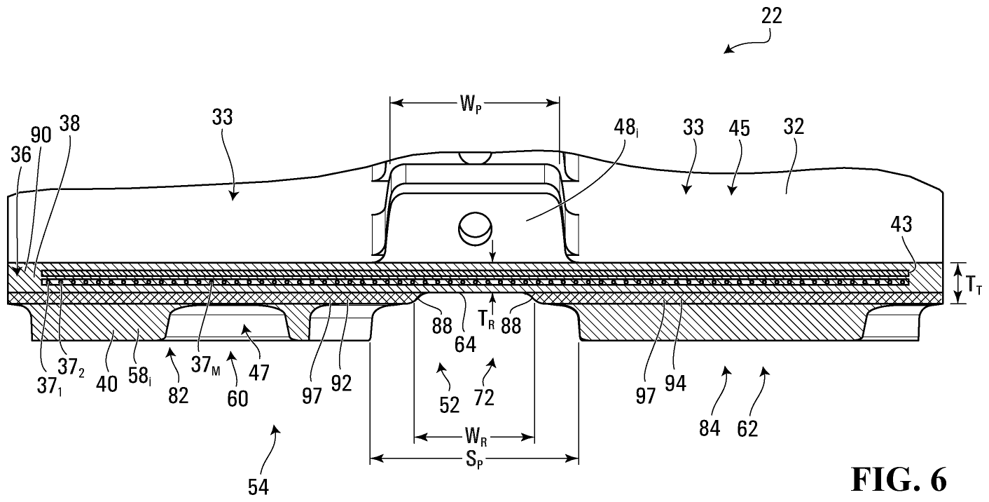

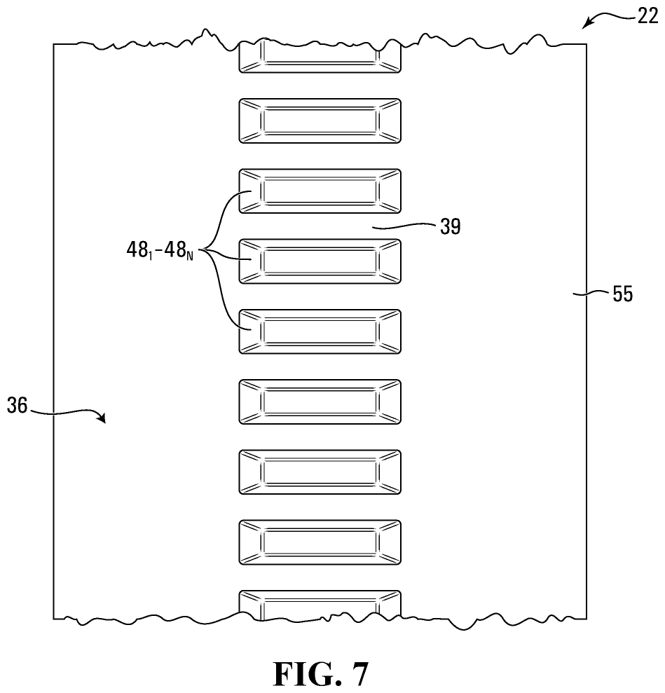

The track 22 engages the ground to provide traction to the agricultural vehicle 10. A length of the track 22 allows the track 22 to be mounted around the track-engaging assembly 21. In view of its closed configuration without ends that allows it to be disposed and moved around the track-engaging assembly 21, the track 22 can be referred to as an “endless” track. With additional reference to FIGS. 3 to 7, the track 22 comprises an inner side 45, a ground-engaging outer side 47, and lateral edges 49₁, 49₂. The inner side 45 faces the wheels 24, 26, 28₁-28₆, while the ground-engaging outer side 47 engages the ground. A top run 65 of the track 22 extends between the longitudinal ends 57, 59 of the track system 16 and over the wheels 24, 26, 28₁-28₆, while a bottom run 66 of the track 22 extends between the longitudinal ends 57, 59 of the track system 16 and under the wheels 24, 26, 28₁-28₆. The bottom run 66 of the track 22 defines an area of contact 63 of the track 22 with the ground which generates traction and bears a majority of a load on the track system 16, and which will be referred to as a “contact patch” of the track 22 with the ground. The track 22 has a longitudinal axis 19 which defines a longitudinal direction of the track 22 (i.e., a direction generally parallel to its longitudinal axis) and transversal directions of the track 22 (i.e., directions transverse to its longitudinal axis), including a widthwise direction of the track 22 (i.e., a lateral direction generally perpendicular to its longitudinal axis). The track 22 has a thickness direction normal to its longitudinal and widthwise directions.

In this embodiment, the track 22 is relatively wide to efficiently distribute load of the vehicle 10 over the soil. For instance, in some embodiments, the width W_{T} of the track 22 may be at least 24 inches, in some cases at least 36 inches, in some cases at least 48 inches, in some cases even more.

The track 22 is elastomeric, i.e., comprises elastomeric material, to be flexible around the track-engaging assembly 21. The elastomeric material of the track 22 can include any polymeric material with suitable elasticity. In this embodiment, the elastomeric material of the track 22 includes rubber. Various rubber compounds may be used and, in some cases, different rubber compounds may be present in different areas of the track 22. In other embodiments, the elastomeric material of the track 22 may include another elastomer in addition to or instead of rubber (e.g., polyurethane elastomer).

More particularly, the track 22 comprises an endless body 36 underlying its inner side 45 and ground-engaging outer side 47. In view of its underlying nature, the body 36 will be referred to as a “carcass”. In this embodiment, the carcass 36 comprises a base 90. The carcass 36 and the base 90 thereof are elastomeric in that the base 90 comprises elastomeric material 38 which allows the carcass 36 to elastically change in shape and thus the track 22 to flex as it is in motion around the track-engaging assembly 21.

In this embodiment, the carcass 36 comprises a plurality of reinforcements. Specifically, in this embodiment, the base of the carcass 36 comprises a plurality of reinforcements embedded in its elastomeric material 38 and spaced from one another. These reinforcements can take on various forms, such as reinforcing layers.

For example, in this embodiment, the base 90 of the carcass 36 comprises a layer of reinforcing cables 37₁-37_{M} that are adjacent to one another and extend generally in the longitudinal direction of the track 22 to enhance strength in tension of the track 22 along its longitudinal direction. In this case, each of the reinforcing cables 37₁-37_{M} is a cord including a plurality of strands (e.g., textile fibers or metallic wires). In other cases, each of the reinforcing cables 37₁-37_{M} may be another type of cable and may be made of any material suitably flexible along the cable's longitudinal axis (e.g., fibers or wires of metal, plastic or composite material).

As another example, in this embodiment, the base 90 of the carcass 36 comprises a layer of reinforcing fabric 43. The reinforcing fabric 43 comprises thin pliable material made usually by weaving, felting, knitting, interlacing, or otherwise crossing natural or synthetic elongated fabric elements, such as fibers, filaments, strands and/or others, such that some elongated fabric elements extend transversally to the longitudinal direction of the track 22 to have a reinforcing effect in a transversal direction of the track 22. For instance, the reinforcing fabric 43 may comprise a ply of reinforcing woven fibers (e.g., nylon fibers or other synthetic fibers).

The carcass 36 may be molded into shape in a molding process during which the rubber 38 is cured. For example, in this embodiment, a mold may be used to consolidate layers of rubber providing the rubber 38 of the carcass 36, the reinforcing cables 37₁-37_{M} and the layer of reinforcing fabric 43.

The inner side 45 of the endless track 22 comprises an inner surface 32 of the carcass 36 and a plurality of wheel-contacting projections 48₁-48_{N} that project from the inner surface 32 and are positioned to contact at least some of the wheels 24, 26, 28₁-28 to do at least one of driving (i.e., imparting motion to) the track 22 and guiding the track 22. The wheel-contacting projections 48₁-48_{N} can be referred to as “wheel-contacting lugs”. Furthermore, since each of them is used to do at least one of driving the track 22 and guiding the track 22, the wheel-contacting lugs 48₁-48_{N} can be referred to as “drive/guide projections” or “drive/guide lugs”. In some examples of implementation, a drive/guide lug 48ᵢ may interact with the drive wheel 24 to drive the track 22, in which case the drive/guide lug 48ᵢ is a drive lug. In other examples of implementation, a drive/guide lug 48ᵢ may interact with the idler wheel 26 and/or the roller wheels 28₁-28 to guide the track 22 to maintain proper track alignment and prevent de-tracking without being used to drive the track 22, in which case the drive/guide lug 48ᵢ is a guide lug. In yet other examples of implementation, a drive/guide lug 48ᵢ may both (i) interact with the drive wheel 24 to drive the track and (ii) interact with the idler wheel 26 and/or the roller wheels 28₁-28₆ to guide the track 22 to maintain proper track alignment and prevent de-tracking, in which case the drive/guide lug 48ᵢ is both a drive lug and a guide lug.

In this embodiment, the drive/guide lugs 48₁-48_{N} interact with the drive wheel 24 in order to cause the track 22 to be driven, and also interact with the idler wheel 26 and the roller wheels 28₁-28₆ in order to guide the track 22 as it is driven by the drive wheel 24 to maintain proper track alignment and prevent de-tracking. The drive/guide lugs 48₁-48_{N} are thus used to both drive the track 22 and guide the track 22 in this embodiment.

In this example of implementation, the drive/guide lugs 48₁-48_{N} are arranged in a single row disposed longitudinally along the inner side 45 of the track 22. The drive/guide lugs 48₁-48_{N} may be arranged in other manners in other examples of implementation (e.g., in a plurality of rows that are spaced apart along the widthwise direction of the track 22).

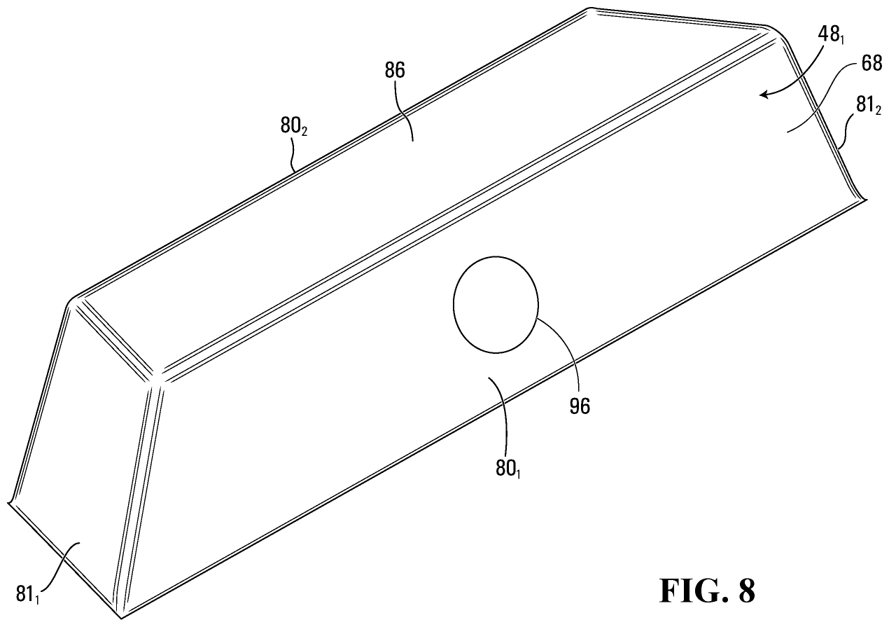

The drive/guide lugs 48₁-48_{N} may have any suitable shape. With additional reference to FIG. 8, each drive/guide lug 48ᵢ has a periphery 69 which, in this embodiment, includes a front surface 80₁, a rear surface 80₂, two lateral surfaces 81₁, 81₂, and a top surface 86. The front surface 80₁ and the rear surface 80₂ are opposed to one another along the longitudinal direction of the track 22. In this embodiment where the drive/guide lug 48ᵢ is used to drive the track 22, each of the front surface 80₁ and the rear surface 80₂ constitutes a drive surface which can be contacted by a drive member of the drive wheel 24 that pushes against it to impart motion to the track 22. The two lateral surfaces 81₁, 81₂ are laterally opposed and may contact the roller wheels 28₁-28₆, the drive wheel 24 and/or the idler wheel 26 such as to prevent excessive lateral movement of the track 22 relative the wheels and to thus prevent de-tracking. In this embodiment, the drive/guide lug 48ᵢ further comprises an aperture 96 which reduces a weight of the drive/guide lug 48ᵢ and consequently reduces a weight of the track 21 and diminishes manufacturing cost of the track 21. In this example, the aperture 96 is a circular aperture extending from the front surface 80₁ to the rear surface 80₂ at a mid-distance between the lateral surfaces 81₁, 81₂. Although it has a certain shape in this embodiment, the periphery 69 of the drive/guide lug 48ᵢ may have various other shapes in other embodiments.

In this embodiment, the drive/guide lug 48ᵢ is configured to interact with the idler wheel 26 and/or the roller wheels 28₁-28₆ when they are aligned with one another, such that the lateral surfaces 81₁, 81₂ of each drive/guide lug 48ᵢ face respecting ones of the roller wheels 28₁-28₆ when they are aligned with one another.

In this embodiment, each drive/guide lug 48ᵢ is an elastomeric drive/guide lug in that it comprises elastomeric material 67. The elastomeric material 67 can be any polymeric material with suitable elasticity. More particularly, in this embodiment, the elastomeric material 67 includes rubber. Various rubber compounds may be used and, in some cases, different rubber compounds may be present in different areas of the drive/guide lug 48ᵢ. In other embodiments, the elastomeric material 67 may include another elastomer in addition to or instead of rubber (e.g., polyurethane elastomer). The drive/guide lugs 48₁-48_{N} may be provided on the inner side 45 in various ways. For example, in this embodiment, the drive/guide lugs 48₁-48_{N} are provided on the inner side 45 by being molded with the carcass 36.

The ground-engaging outer side 47 comprises a ground-engaging outer surface 31 of the carcass 36 and a tread pattern 40 to enhance traction on the ground. The tread pattern 40 comprises a plurality of traction projections 58₁-58_{T} projecting from the ground-engaging outer surface 31, spaced apart in the longitudinal direction of the endless track 22 and engaging the ground to enhance traction. The traction projections 58₁-58_{T} may be referred to as “tread projections” or “traction lugs”.

In this embodiment, the base 90 of the carcass 36 includes the inner surface 32 of the carcass 36 and part of the ground-engaging outer surface 31 of the carcass 36.

Each traction lug 58ᵢ has a front-to-rear dimension L_{L} in the longitudinal direction of the endless track 22 and a side-to-side dimension L_{W} in the widthwise direction of the endless track 22. In some cases, the front-to-rear dimension L_{L} may be a width of the traction lug 58ᵢ while the side-to-side dimension L_{W} may be a length of the traction lug 58ᵢ. In other cases, the front-to-rear dimension L_{L} may be a length of the traction lug 58ᵢ while the side-to-side dimension L_{W} may be a width of the traction lug 58ᵢ. In yet other cases, the front-to-rear dimension L_{L} and the side-to-side dimension L_{W} may be substantially the same. The traction lug 58ᵢ also has a height H.

The traction lugs 58₁-58_{T} may have any suitable shape. In this embodiment, each of the traction lugs 58₁-58_{T} has an elongated shape and is angled, i.e., defines an oblique angle θ (i.e., an angle that is not a right angle or a multiple of a right angle), relative to the longitudinal direction of the track 22. The traction lugs 58₁-58_{T} may have various other shapes in other examples (e.g., curved shapes, shapes with straight parts and curved parts, etc.).

In this embodiment, each traction lug 58ᵢ is an elastomeric traction lug in that it comprises elastomeric material 41. The elastomeric material 41 can be any polymeric material with suitable elasticity. More particularly, in this embodiment, the elastomeric material 41 includes rubber. Various rubber compounds may be used and, in some cases, different rubber compounds may be present in different areas of the traction lug 58ᵢ. In other embodiments, the elastomeric material 41 may include another elastomer in addition to or instead of rubber (e.g., polyurethane elastomer). The traction lugs 58₁-58_{T} may be provided on the ground-engaging outer side 47 in various ways. For example, in this embodiment, the traction lugs 58₁-58_{T} are provided on the ground-engaging outer side 47 by being molded with the carcass 36.

In this embodiment, the track 22 comprises a pressure-reducing zone 52 configured to cause pressure on the ground beneath the pressure-reducing zone 52 of the track 22 to be lower than pressure on the ground beneath an adjacent portion 54 of the track 22 that is adjacent to the pressure-reducing zone 52 of the track 22 in the widthwise direction of the track 22. For example, in some embodiments, the pressure-reducing zone 52 of the track 22 may be configured to cause the pressure on the ground beneath the pressure-reducing zone 52 of the track 22 to be no more than half, in some cases no more than one quarter, in some cases no more than one tenth, and in some cases no more than an even smaller fraction of the pressure on the ground beneath the adjacent portion 54 of the track 22. In some embodiments, the pressure-reducing zone 52 of the track 22 may be configured to cause the pressure on the ground beneath the pressure-reducing zone 52 of the track 22 to be substantially null.

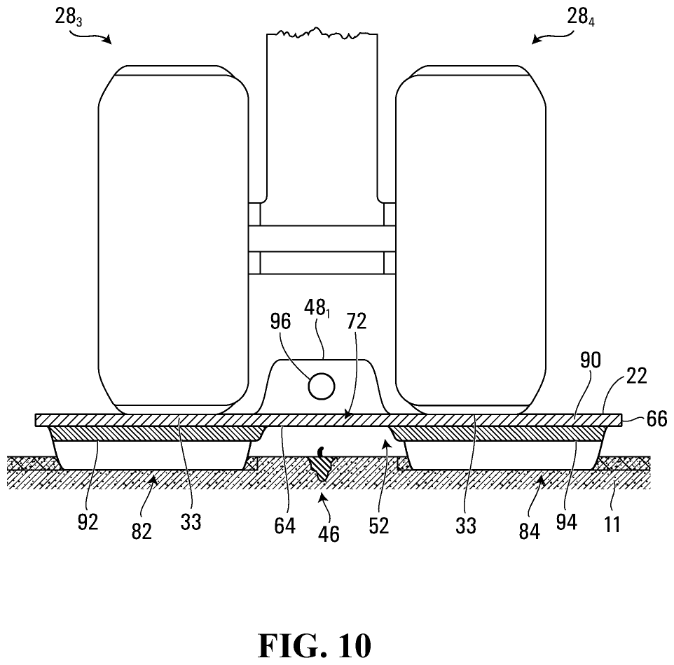

With additional reference to FIGS. 1 and 10, in this embodiment, the track 22 is configured to overlie (i.e., pass over or upon) a planting row 46 of the agricultural field 11 such that the pressure-reducing zone 52 of the track 22 overlies (i.e., passes over or upon) the planting row 46 of the agricultural field 11. This allows the track 22 to provide traction and floatation, even if planting rows are close to one another in the agricultural field, by passing on the planting row 46 of the agricultural field as the pressure-reducing zone 22 of the track 22 causes the pressure on the planting row 46 of the agricultural field to be minimal or null, thus protecting against soil compaction at the planting row 46 of the agricultural field.

In this embodiment, the adjacent portion 54 of the track 22 comprises adjacent parts 60, 62 of the track 22 between which the pressure-reducing zone 52 of the track 22 is disposed in the widthwise direction of the track 22, such that the pressure on the ground beneath the pressure-reducing zone 52 of the track 22 is lower than the pressure on the ground beneath each of the adjacent parts 60, 62 of the track 22.

More particularly, in this embodiment, the pressure-reducing zone 52 of the track 22 comprises an area 72 of the ground-engaging outer surface 31 of the carcass 36 between respective ones of the traction projections 58₁-58_{T} that are spaced from one another in the widthwise direction of the track 22. In this example, the adjacent part 54 of the track 22 comprises a first subset of the traction projections 58₁-58_{T} arranged in a first longitudinal row 82, and the adjacent part 54 of the track 22 comprises a second subset of the traction projections 58₁-58_{T} arranged in a second longitudinal row 84 that is spaced apart from the first longitudinal row 82 in the widthwise direction of the track 22 by the pressure-reducing zone 52 of the track 22. In this case, the pressure-reducing zone 52 of the track 22 is a longitudinal pressure-reducing zone extending along the longitudinal direction of the track 22.

More specifically, in this embodiment, the area 72 of the ground-engaging outer surface 31 comprises a recess 64.

The recess 64 may have any suitable dimensions. For example, in some embodiments, a thickness T_{R} of the carcass 36 from the ground-engaging outer surface 31 to the inner surface 32 at the recess 64 of the ground-engaging outer surface 31 is no more than 90%, in some embodiments no more than 80%, in some embodiments no more than 70% and in some embodiments even a smaller proportion (e.g., no more than 60%) of the thickness TT of the carcass 36 away from the recess 64 of the ground-engaging outer surface 31.

As another example, in some embodiments, a dimension W_{R} of the recess 64 in the widthwise direction of the track 22 (e.g., a width of the recess 64) may be sufficiently large for planting rows of crops under the pressure-reducing zone 52 of the track 22, and may correspond to at least majority of a spacing S_{P} of respective ones of the traction projections 58₁-58_{T} in the widthwise direction of the track 22 and to at least a majority of a width WP of a given one of the wheel-contacting projections 48₁-48_{N} in the widthwise direction of the track 22. In some embodiments, the dimension W_{R} of the recess 64 in the widthwise direction of the track 22 corresponds to at least 80% of the spacing S_{P}, in some embodiments corresponds to at least 90% of the spacing S_{P}, and in some embodiments corresponds to the spacing S_{P} of the respective ones of the traction projections 58₁-58_{T} in the widthwise direction of the track 22. In some embodiments, the dimension W_{R} of the recess 64 in the widthwise direction of the track 22 corresponds to at least 5%, in some embodiments to at least 10% and in some embodiments to even more (e.g., at least 15%) of the width W_{T} of the track 22.

As another example, in some embodiments, while allowing planting rows of crops under the pressure-reducing zone 52 of the track 22, the dimension W_{R} of the recess 64 in the widthwise direction of the track 22 may be small enough to allow an increased weight distribution of the vehicle 10 by the track 22 and therefore increase the performances (e.g., traction, floatation, maximum speed) of the track system 16 and/or the agricultural vehicle 10. For instance, in some embodiments, the dimension W_{R} of the recess 64 in the widthwise direction of the track 22 corresponds to no more than 50%, in some embodiments to no more than 30%, in some embodiments to no more than 20%, in some embodiments to no more than 15%, in some embodiments to no more than 10% and in some embodiments to even less (e.g., no more than 5%) of the width W_{T} of the track 22.

In this embodiment, the recess 64 recedes transversally to the thicknesswise direction of the track 22. In particular, the recess 64 may comprise sidewalls 88 that are opposite one another and curved.

Specifically, in this embodiment, the recess 64 is a channel extending along the longitudinal direction of the track 22 for a substantial portion of the length of the track 22. For instance, in this embodiment, the channel 64 may extend along the longitudinal direction of the track 22 for at least a majority (i.e., a majority or an entirety) of the length of the track. More specifically, in this embodiment, the channel 64 may extend along the longitudinal direction of the track for an entirety of the length of the track 22.

In this embodiment, the area 72 is disposed in a widthwise center of the track 22 and the channel 64 intersects a centerline 53 of the track 22 that bisects the width W_{T} of the track 22. The channel 64 may be a planting channel configured to overlie the planting row 46 of the agricultural field.

The carcass 36 may further comprise a first outer member 92 disposed between the base 90 and the first longitudinal row 82 of traction projections 58₁-58_{T} and including part of the ground-engaging surface 31, and a second outer member 94 disposed between the base 90 and the second longitudinal row 84 of the traction projections 58₁-58_{T} and including part of the ground-engaging surface 31. In this embodiment, the outer members 92, 94 of the carcass 36, which may be referred-to as “pads”, are spaced apart in the widthwise direction of the track 22 to form the channel 64 therebetween. Specifically, in this embodiment, each one of the outer members 92, 94 define respective ones of the sidewalls 88.

In this embodiment, each of the outer members 92, 94 may comprise an elastomeric material 97 and may be free of any reinforcing layer. The elastomeric material 97 of the outer members 92, 94 of the carcass 36 may be different from the elastomeric material 38 of the base 90 of the carcass 36. For instance, a modulus of elasticity of the elastomeric material 97 of the outer members 92, 94 of the carcass 36 may be different from a modulus of elasticity of the elastomeric material 38 of the base 90 of the carcass 36. In particular, the modulus of elasticity of the elastomeric material 97 of each of the outer members 92, 94 of the carcass 36 may be greater than the modulus of elasticity of the elastomeric material 38 of the base 90 of the carcass 36. As another example, a hardness of the elastomeric material 97 of the outer members 92, 94 of the carcass 36 may be different from a hardness of the elastomeric material 38 of the base 90 of the carcass 36. In particular, the hardness of the elastomeric material 97 of each of the outer members 92, 94 of the carcass 36 may be greater than the hardness of the elastomeric material 38 of the base 90 of the carcass 36. Moreover, in this embodiment, the track 22 in the pressure-reducing zone 52 of the track 22 is more flexible (i.e., less stiff) than the track 22 in the adjacent portion 54 of the track 22.

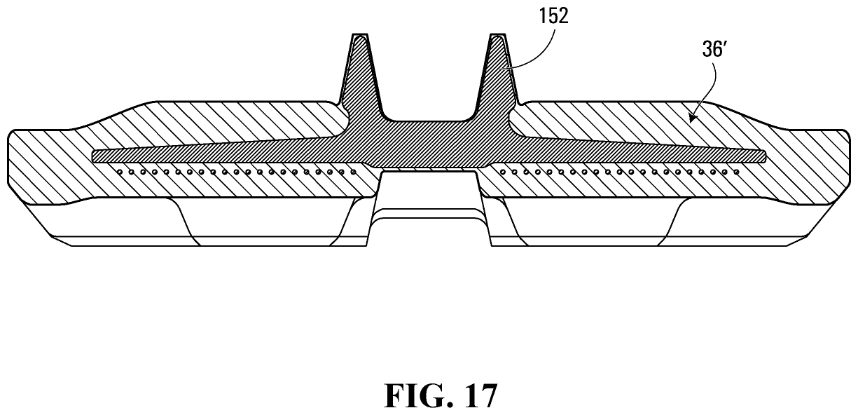

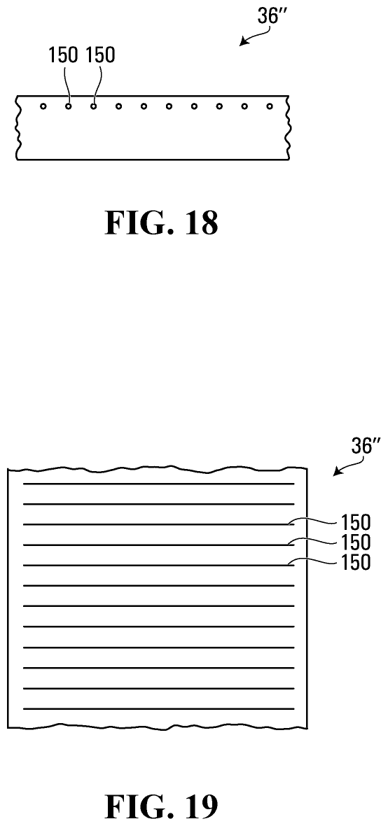

In this embodiment, the track 22 may be free of stiffening bars (such as metallic cores or metallic or fiber-reinforced composite rods) embedded in the carcass 36, extending transversally to the longitudinal direction of the track 22, and spaced apart in the longitudinal direction of the track 22. An example of another track comprising stiffening cores 152 embedded in its carcass 36′, extending transversally to its longitudinal direction, and spaced apart in its longitudinal direction is shown in FIG. 17. Another example of another track comprising stiffening bars 150 embedded in its carcass 36″, extending transversally to its longitudinal direction, and spaced apart in its longitudinal direction is shown in FIGS. 18 and 19.

The drive wheel 24 is rotatable by power derived from the prime mover 14 to drive the track 22. That is, power generated by the prime mover 14 and delivered over the powertrain 15 of the agricultural vehicle 10 can rotate a final drive axle 56ᵢ, which causes rotation of the drive wheel 24, which in turn imparts motion to the track 22.

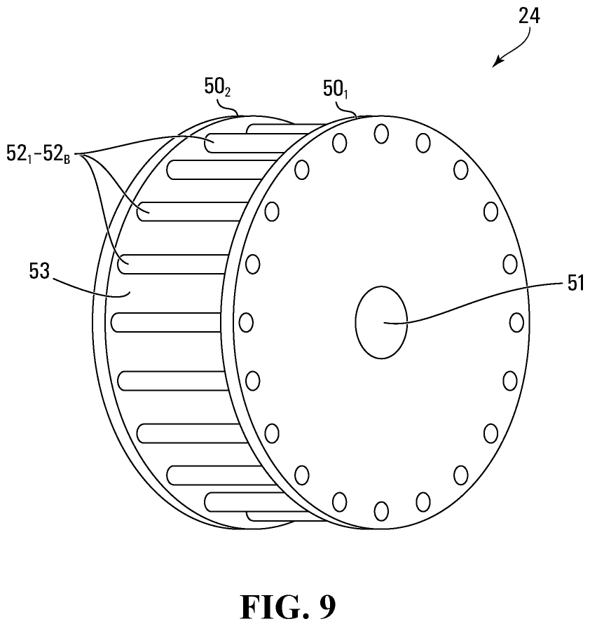

With additional reference to FIG. 9, in this embodiment, the drive wheel 24 comprises a drive sprocket comprising a plurality of drive members 52₁-52_{B} spaced apart along a circular path to engage the drive/guide lugs 48₁-48_{N} of the track 22 in order to drive the track 22. The drive wheel 24 and the track 22 thus implement a “positive drive” arrangement. More particularly, in this embodiment, the drive wheel 24 comprises two side discs 50₁, 50₂ which are co-centric and turn about a common axle 51 and between which the drive members 52₁-52_{B} extend near respective peripheries of the side discs 50₁, 50₂. In this example, the drive members 52₁-52_{B} are thus drive bars that extend between the side discs 50₁, 50₂. The drive wheel 24 and the track 22 have respective dimensions allowing interlocking of the drive bars 52₁-52_{B} of the drive wheel 24 and the drive/guide lugs 48₁-48_{N} of the track 22. Adjacent ones of the drive bars 52₁-52_{B} define an interior space 53 between them to receive one of the drive/guide lugs 48₁-48_{N}. Adjacent ones of the drive/guide lugs 48₁-48_{N} define an inter-lug space 39 between them to receive one of the drive bars 52₁-52_{B}. The drive/guide lugs 48₁-48_{N} and the drive bars 52₁-52_{B} have a regular spacing that allows interlocking of the drive/guide lugs 48₁-48_{N} and the drive bars 52₁-52_{B} over a certain length of the drive wheel's circumference.

The drive wheel 24 may be configured in various other ways in other embodiments. For example, in other embodiments, the drive wheel 24 may not have any side discs such as the side discs 50₁, 50₂. As another example, in other embodiments, instead of being drive bars, the drive members 52₁-52_{B} may be drive teeth that are distributed circumferentially along the drive wheel 24 or any other type of drive members. As another example, in embodiments where the track 22 comprises recesses or holes, the drive wheel 24 may have teeth that enter these recesses or holes in order to drive the track 22. As yet another example, in some embodiments, the drive wheel 24 may frictionally engage the inner side 45 of the track 22 in order to frictionally drive the track 22 (i.e., the drive wheel 24 and the track 22 may implement a “friction drive” arrangement).

The front idler and roller wheels 26, 28₁-28₆ are not driven by power supplied by the prime mover 14, but are rather used to do at least one of supporting part of the weight of the agricultural vehicle 10 on the ground via the track 22, guiding the track 22 as it is driven by the drive wheel 24, and tensioning the track 22. More particularly, in this embodiment, the front idler wheel 26 is a leading idler wheel which maintains the track 22 in tension and help to support part of the weight of the agricultural vehicle 10 on the ground via the track 22. As shown in FIG. 10, the roller wheels 28₁-28₆ roll on a rolling path 33 of the inner side 45 of the track 22 along the bottom run 66 of the track 22 to apply the bottom run 66 on the ground. In this case, as they are located between frontmost and rearmost ones of the wheels of the track system 16, the roller wheels 28₁-28₆ can be referred to as “mid-rollers”.

Since the track systems 16, including the track 22, are configured to reduce soil compaction of at least a portion of the soil 11 underlying each track 22, the track systems 16 and/or the tracks 22 may be provided to reduce soil compaction by causing the agricultural vehicle 10 to move on the soil 11 such that the pressure-reducing zone 52 of the track 22 overlies a planting row 46 of the agricultural field.

The track system 16, including the track 22, may be implemented in any other suitable way in other embodiments.

For example, track 22 may be constructed in various other manners in other embodiments. For example, in some embodiments, the track 22 may have recesses or holes that interact with the drive wheel 24 in order to cause the track 22 to be driven (e.g., in which case the drive/guide lugs 48₁-48_{N} may be used only to guide the track 22 without being used to drive the track 22, i.e., they may be “guide lugs” only), and/or the ground-engaging outer side 47 of the track 22 may comprise various patterns of traction lugs.

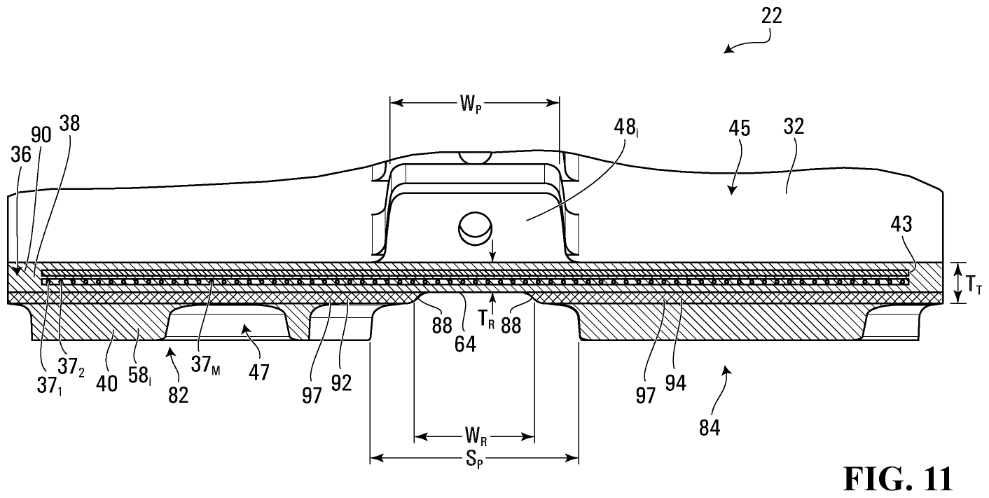

As another example, as shown in FIG. 11, in a variant, the sidewalls 88 of the recess 64 of the track 22 may be opposite one another and beveled.

As another example, in a variant, the modulus of elasticity of the elastomeric material 97 of each of the first outer member 92 and the second outer member 94 of the carcass 36 may be smaller than the modulus of elasticity of the elastomeric material 38 of the base 90 of the carcass 36, and the hardness of the elastomeric material 97 of each of the first outer member 92 and the second outer member 94 of the carcass 36 may be smaller than the hardness of the elastomeric material 38 of the base 90 of the carcass 36.

As another example, in a variant, the mechanical properties of the elastomeric material 97 of the outer members 92, 94 of the carcass 36 may be similar to or identical with the mechanical properties of the elastomeric material 38 of the base 90 of the carcass 36. More specifically, in this variant, the elastomeric material 97 is identical to the elastomeric material 38 of the base 90 of the carcass 36. In this variant, the outer members 92, 94 of the carcass 36 may be integrally made with the base 90 of the carcass 36, and the base 90 and the outer members 92, 94 may be molded into shape together during a same molding process.

As another example, in a variant, the elastomeric material of the carcass 36 of the track 22 in the pressure-reducing zone 52 of the track 22 may more flexible than elastomeric material of the carcass 36 of the track 22 in the adjacent portion 54 of the track 22.

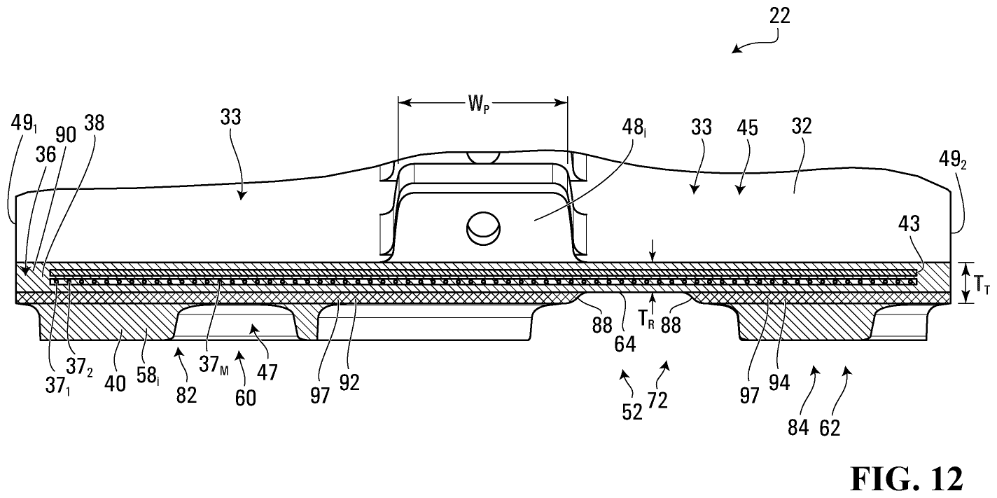

As another example, as shown in FIG. 12, the area 72 of the track 22 may not be disposed in the widthwise center of the track 22 and the channel 64 may not intersect the centerline 53 of the track 22 that bisects the width W_{T} of the track 22. In this variant, the area 72 of the track 22 and the channel 64 are closer to a given one of the lateral edges 49₁, 49₂ of the track 22 than to the other one of the lateral edges 49₁, 49₂ of the track 22. In this variant, the dimension L_{W} of the traction projections of the first longitudinal row 82 may be different from (e.g., smaller than, greater than) the dimension L_{W} of the traction projections of the second longitudinal row 84, a width of the first adjacent part 60 of the track 22 may be different from (e.g., smaller than, greater than) a width of the second adjacent part 62 of the track 22, and a width of the first outer member 92 of the carcass 36 may be different from (e.g., smaller than, greater than) a width of the second outer member 94 of the carcass 36.

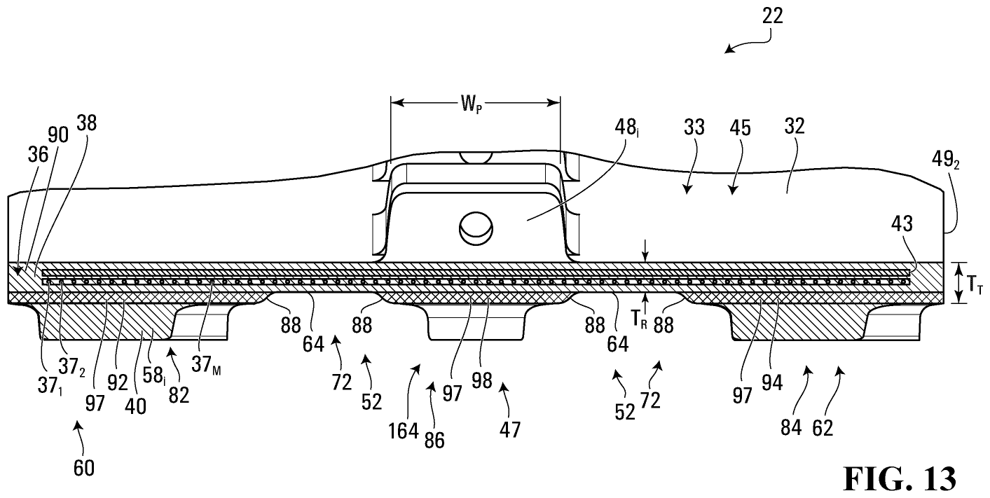

As another example, as shown in FIG. 13, the track 22 may comprise more than one (e.g., 2, 3, 4 or more) pressure-reducing zones 52. For instance, in this variant, the traction projections 58₁-58_{T} of the track 22 comprise more than two (e.g., 3, 4, 5 or more) subsets of traction projections 58₁-58_{T} arranged in distinct longitudinal rows, and the adjacent portion 54 of the track 22 comprises more than two adjacent parts. Specifically, in this embodiment, adjacent portion 54 of the track 22 comprises a third adjacent part 164, the track 22 comprises a third subset of traction projections 58₁-58_{T} arranged in a third longitudinal row 86 and the carcass 36 comprises a third outer member 98 comprising the elastomeric material 97, such that the track comprises two areas 72 and channels 64 disposed between respective ones of the longitudinal rows 82, 84, 86, each channel 64 being configured to overly a respective planting row 46. The third longitudinal row 86 and the third outer member 98 may have any suitable dimensions relative to dimensions of the longitudinal rows 82, 84 and relative to the outer members 92, 94. For instance, in this variant, a width of the longitudinal row 86 in the widthwise direction of the track 22 is identical to a width of the longitudinal rows 82, 84 in the widthwise direction of the track 22, and a width of the outer member 98 in the widthwise direction of the track 22 is identical to a width of the outer members 92, 94 in the widthwise direction of the track 22. In other variants, the width of the longitudinal row 86 in the widthwise direction of the track 22 may be different from (e.g., smaller than, greater than) the width of the longitudinal rows 82, 84 in the widthwise direction of the track 22, and the width of the outer member 98 in the widthwise direction of the track 22 may be different from (e.g., smaller than, greater than) the width of the outer members 92, 94 in the widthwise direction of the track 22.

Although the agricultural vehicle 10 illustrated in FIG. 1 is an agricultural tractor comprising two track systems 16, different types of agricultural vehicles configured differently (e.g., having a different number of track systems) may implement improvements based on principles disclosed herein.

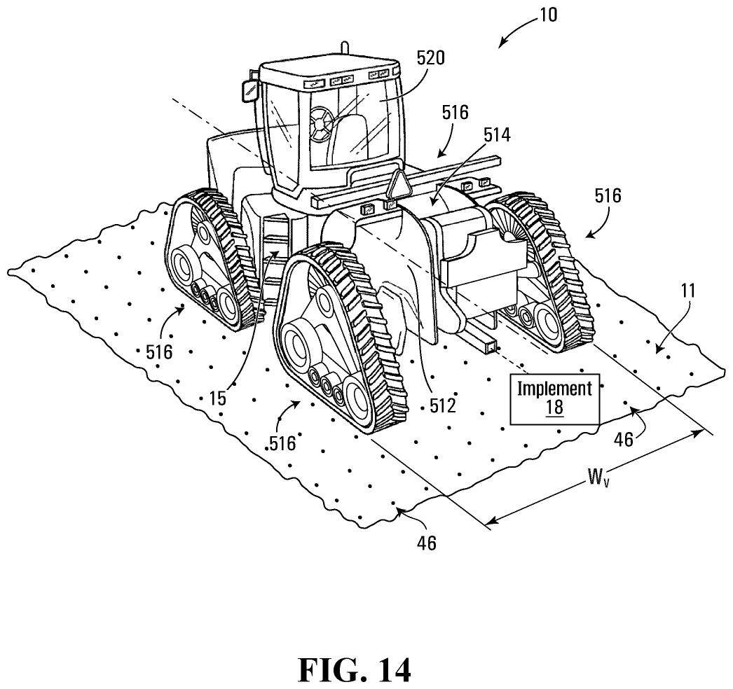

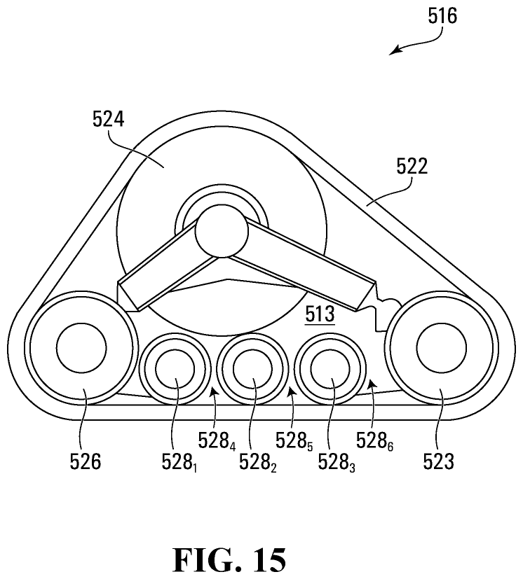

For instance, with additional reference to FIGS. 14 and 15, an agricultural vehicle 510 may be provided comprising four track systems 516 rather than two (i.e., two track systems 516 at each side of the agricultural vehicle 510). The agricultural vehicle 510 also comprises a frame 512, a prime mover 514, a powertrain 515 and an operator cabin 520 and can be equipped with the work implement 18 to perform agricultural work. Each track system 516 comprises a frame 513, a drive wheel 524, a front idler wheel 523 at a first longitudinal end portion of the track system 516, a rear idler wheel 526 at a second longitudinal end portion of the track system 516 opposite to the first longitudinal end portion, and a plurality of mid-rollers 528₁-528₆ intermediate the drive wheel 524 and the idler wheel 526. The track system 516 further comprises a track 522 disposed around the wheels 524, 526, 528₁-528₆ and driven by the drive wheel 524. The track 522 may be configured in a manner similar to the track 22 as described in section 2 above.

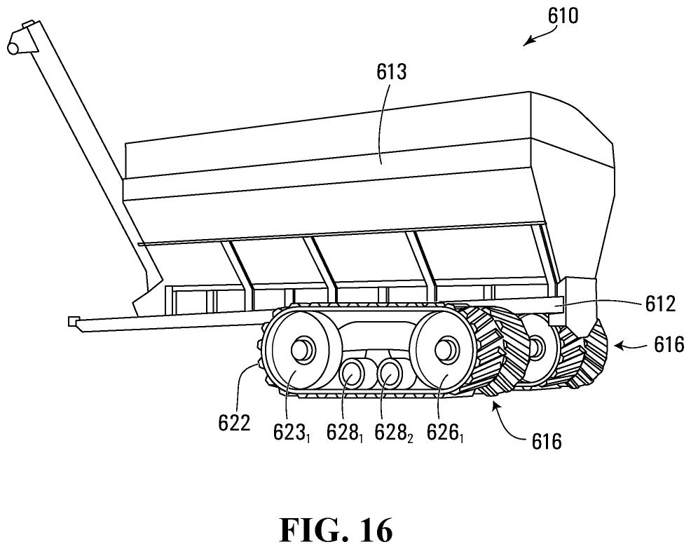

Furthermore, the work implement 18 that is drawn by the agricultural vehicle 10 or the agricultural vehicle 510 may implement the improvements disclosed herein. For instance, with additional reference to FIG. 16, the work implement 18 may comprise a trailed vehicle 610 comprising a frame 612, a body 613 (e.g., a container) and track systems 616₁, 616₂. In this example, the trailed vehicle 610 is a harvest cart. In other examples, the trailed vehicle 610 may be a fertilizer cart, a sprayer, a planter or any other suitable type of trailed vehicle. Each track system 616 of the trailed vehicle 610 comprises front (i.e., leading) idler wheels 623₁, 623₂ at a first longitudinal end portion of the track system 616, rear (i.e., trailing) idler wheels 626₁, 626₂ at a second longitudinal end portion of the track system 616 opposite the first longitudinal end portion, and a plurality of mid-rollers 628₁-628₄ intermediate the front idler wheels 623₁, 623₂ and the rear idler wheels 626₁, 626₂. The track system 616 further comprises a track 622 disposed around the wheels 626₁, 626₂, 626₁, 626₂, 628₁-628₄. The track 622 may be configured in a manner similar to the track 22 as described in section 2 above.

In this example, the trailed vehicle 610 is not motorized in that it does not comprise a prime mover for driving the track systems 616₁, 616₂. Rather, the trailed vehicle 610 is displaced by the agricultural vehicle 10 or the agricultural vehicle 510 to which the trailed vehicle 610 is attached. However, in some examples, the trailed vehicle 610 may be motorized. That is, the trailed vehicle 610 may comprise a prime mover for driving a drive wheel of each track system 616. For example, instead of comprising rear idler wheels 626₁, 626₂, the track system 616 may comprise a drive wheel for driving the track 622.

Although in embodiments considered above the vehicle 10 is an agricultural vehicle operable by a user from the operator cabin 20, in some embodiments, the vehicle 10 may be operable by a user remotely. In some embodiments, the vehicle 10 may comprise autonomy features, allowing the vehicle 10 to be semi-autonomous and/or entirely autonomous. In some embodiments, the vehicle 10 may be free of any operator cabin.

While in embodiments considered above the vehicle 10 is an agricultural vehicle, in other embodiments, the vehicle 10 may be an industrial vehicle such as a construction vehicle (e.g., a loader, a telehandler, a bulldozer, an excavator, etc.) for performing construction work or a forestry vehicle (e.g., a feller-buncher, a tree chipper, a knuckleboom loader, etc.) for performing forestry work, a military vehicle (e.g., a combat engineering vehicle (CEV), etc.) for performing military work, an all-terrain vehicle (ATV), a snowmobile, or any other vehicle operable off paved roads. Although operable off paved roads, the vehicle 10 may also be operable on paved roads in some cases.

In some examples of implementation, any feature of any embodiment described herein may be used in combination with any feature of any other embodiment described herein.

Certain additional elements that may be needed for operation of some embodiments have not been described or illustrated as they are assumed to be within the purview of those of ordinary skill in the art. Moreover, certain embodiments may be free of, may lack and/or may function without any element that is not specifically disclosed herein.

In case of any discrepancy, inconsistency, or other difference between terms used herein and terms used in any document incorporated by reference herein, meanings of the terms used herein are to prevail and be used.

Although various embodiments and examples have been presented, this was for purposes of description, but should not be limiting. Various modifications and enhancements will become apparent to those of ordinary skill in the art.

1-85. (canceled)

86. A track for traction of a vehicle, the track being mountable around a track-engaging assembly comprising a plurality of wheels, the track being elastomeric to flex around the track-engaging assembly, the track comprising:
a carcass comprising a ground-engaging outer surface for engaging a ground and an inner surface opposite to the ground-engaging outer surface; and
a plurality of traction projections projecting from the ground-engaging outer surface; wherein the track comprises a pressure-reducing zone configured to cause pressure on the ground beneath the pressure-reducing zone of the track to be lower than pressure on the ground beneath an adjacent portion of the track that is adjacent to the pressure-reducing zone of the track in a widthwise direction of the track.

87. The track of claim 86, wherein the pressure-reducing zone of the track is configured to cause the pressure on the ground beneath the pressure-reducing zone of the track to be no more than half of the pressure on the ground beneath the adjacent portion of the track.

88. The track of claim 86, wherein: the adjacent portion of the track comprises a first adjacent part of the track and a second adjacent part of the track; and the pressure-reducing zone of the track is disposed between the first adjacent part of the track and the second adjacent part of the track in the widthwise direction of the track.

89. The track of claim 86, wherein the pressure-reducing zone of the track is a longitudinal pressure-reducing zone extending along a longitudinal direction of the track.

90. The track of claim 86, wherein the pressure-reducing zone of the track is an area of the ground-engaging surface between respective ones of the traction projections that are spaced from one another in the widthwise direction of the track.

91. The track of claim 86, wherein the pressure-reducing zone of the track comprises a recess of the ground-engaging outer surface and wherein a thickness of the carcass from the ground-engaging outer surface to the inner surface at the recess of the ground-engaging outer surface is no more than 90% of the thickness of the carcass away from the recess of the ground-engaging outer surface.

92. The track of claim 91, wherein a dimension of the recess in the widthwise direction of the track corresponds to at least majority of a spacing of respective ones of the traction projections in the widthwise direction of the track and wherein the dimension of the recess in the widthwise direction of the track corresponds to the spacing of the respective ones of the traction projections in the widthwise direction of the track.

93. The track of claim 91, wherein the recess recedes transversally to a thickness-wise direction of the track and comprises sidewalls that are opposite one another.

94. The track of claim 91, wherein the recess is a channel extending along a longitudinal direction of the track and wherein the channel extends along the longitudinal direction of the track for at least a majority of a length of the track.

95. The track of claim 94, wherein a first subset of the traction projections is arranged in a first longitudinal row and a second subset of the traction projections is arranged in a second longitudinal row that is spaced apart from the first longitudinal row in the widthwise direction of the track by the channel and wherein the carcass comprises: a base including the inner surface and part of the ground-engaging outer surface; a first outer member disposed between the base and the first subset of the traction projections arranged in the first longitudinal row and including part of the ground-engaging surface; a second outer member disposed between the base and the second subset of the traction projections arranged in the second longitudinal row and including part of the ground-engaging surface; and the first outer member and the second outer member of the carcass are spaced apart in the widthwise direction of the track to form the channel therebetween.

96. The track of claim 95, wherein: the base of the carcass comprises elastomeric material and a reinforcing layer; and each of the first outer member and the second outer member of the carcass comprises elastomeric material and is free of any reinforcing layer, wherein: the reinforcing layer of the base of the carcass is a first reinforcing layer of the base of the carcass; and the base of the carcass comprises a second reinforcing layer spaced from the first reinforcing layer of the base of the carcass and wherein the reinforcing layer of the base of the carcass comprises at least one of a layer of reinforcing cables extending in a longitudinal direction of the track and a layer of reinforcing fabric.

97. The track of claim 96, wherein elastomeric material of each of the first outer member and the second outer member of the carcass is different from elastomeric material of the base of the carcass, wherein a modulus of elasticity of the elastomeric material of each of the first outer member and the second outer member of the carcass is different from a modulus of elasticity of the elastomeric material of the base of the carcass, and wherein the modulus of elasticity of the elastomeric material of each of the first outer member and the second outer member of the carcass is greater than the modulus of elasticity of the elastomeric material of the base of the carcass.

98. The track of claim 97, wherein a hardness of the elastomeric material of each of the first outer member and the second outer member of the carcass is different from a hardness of the elastomeric material of the base of the carcass and wherein the hardness of the elastomeric material of each of the first outer member and the second outer member of the carcass is greater than the hardness of the elastomeric material of the base of the carcass.

99. The track of claim 86, wherein the track is free of at least one of stiffening bars embedded in the carcass, extending transversally to a longitudinal direction of the track, and spaced apart in the longitudinal direction of the track and metallic cores embedded in the carcass, extending transversally to a longitudinal direction of the track, and spaced apart in the longitudinal direction of the track.

100. The track of claim 86, wherein elastomeric material of the carcass in the pressure-reducing zone of the track is more flexible than elastomeric material of the carcass in the adjacent portion of the track.

101. A track for traction of a vehicle, the track being mountable around a track-engaging assembly comprising a plurality of wheels, the track being elastomeric to flex around the track-engaging assembly, the track comprising:
a carcass comprising a ground-engaging outer surface for engaging a ground and an inner surface opposite to the ground-engaging outer surface; and
a plurality of traction projections projecting from the ground-engaging outer surface; wherein the ground-engaging outer surface comprises a recess to reduce pressure on the ground.

102. The track of claim 101, wherein a first subset of the traction projections is arranged in a first longitudinal row and a second subset of the traction projections is arranged in a second longitudinal row that is spaced apart from the first longitudinal row in a widthwise direction of the track by the recess.

103. The track of claim 101, wherein a dimension of the recess in a widthwise direction of the track corresponds to at least majority of a spacing of respective ones of the traction projections in the widthwise direction of the track.

104. The track of claim 101, wherein a thickness of the carcass from the ground-engaging outer surface to the inner surface varies in a widthwise direction of the track to cause pressure on the ground beneath a thinner portion of the carcass to be lower than pressure on the ground beneath a thicker portion of the carcass that is adjacent to the thicker portion of the carcass in the widthwise direction of the track.

105. A method of reducing soil compaction by an agricultural vehicle on an agricultural field, the method comprising: providing a track for traction of the agricultural vehicle, the track being mountable around a track-engaging assembly comprising a plurality of wheels, the track being elastomeric to flex around the track-engaging assembly, the track comprising:
a carcass comprising a ground-engaging outer surface for engaging a ground and an inner surface opposite to the ground-engaging outer surface; and
a plurality of traction projections projecting from the ground-engaging outer surface; wherein the track comprises a pressure-reducing zone configured to cause pressure on the ground beneath the pressure-reducing zone of the track to be lower than pressure on the ground beneath an adjacent portion of the track that is adjacent to the pressure-reducing zone of the track in a widthwise direction of the track; and causing the agricultural vehicle to move on the agricultural field such that the pressure-reducing zone of the track overlies a planting row of the agricultural field.
